(19) United States
(12) Patent Application Publication
(10) Pub. No.: US 2001/0033351 A1
(43) Pub. Date: Oct. 25, 2001

(54) Liquid crystal display unit

(76) Inventors: Manabu Takami, Fukushima-shi (JP); Hidekatsu Shigihara, Fukushima-shi (JP)

Correspondence Address: Dike, Bronstein, Roberts & Cushman, LLP, 130 Water Street, Boston, MA, 02109, US

(21) Appl. No.: 09/784,481

(22) Filed: Feb. 15, 2001

(30) Foreign Application Priority Data
Mar. 22, 2000 (JP) 2000-080799

(51) Int. Cl. G02F 1/1335

(52) U.S. Cl. 349/113

(57) ABSTRACT

The visibility of a reflective display panel is improved by providing reflection enhanced films 4 and 5 on the glass surfaces of the reflective display panel, a bright reflective liquid crystal display unit having less reflected images and high contrast can be obtained.

Of liquid crystal display units that do not use polarizing plates or color filters, on the surfaces of transparent glasses 1 and2 of a liquid crystal display unit using holographic polymer dispersed liquid crystal (HPDLC), cholesteric liquid crystal, chiral nematic liquid crystal, or mixed liquid crystal 3 composed of cholesteric and chiral nematic liquid crystal, reflection enhanced films 4 and 5 are respectively provided, thereby reflection from the glass surfaces is successfully suppressed without reducing incident light, reflected images becomes less, and contrast becomes high, thus providing brightness and improved visibility.

### TECHNICAL FIELDS

The present invention relates to a reflective liquid crystal display unit using cholesteric liquid crystal, chiral nematic liquid crystal, mixed liquid crystal composed of cholesteric liquid crystal and chiral nematic liquid crystal, or holographic polymer dispersed liquid crystal.

### BACKGROUND ART

There is a great demand for low power consumption of a liquid crystal display element used in a portable telephone or a personal digital assistant, which has shown great technical advances in recent years. Therefore, reflective liquid crystal display units which do not need backlighting have been widely developed. For a reflective liquid crystal display unit, the TN or STN mode using two polarizing plates which have conventionally been used for watches and electronic calculators have been employed. However, since two polarizing plates are used, the amount of light absorption is large, reflectance is low, and therefore the display is dark. For the purpose of suppressing the absorption of light by the polarizing plates, the STN mode whereby electrodes are disposed in a cell and the two polarizing plates are reduced to one and the TFT mode using TN liquid crystal have been developed.

Furthermore, for color displays, modes such as the STN-ECB (super twisted nematic-electrically controlled birefringence) mode that do not use color filters having great light absorbency have been developed. Moreover, for liquid crystal display units that do not use polarizing plates or color filters, modes using guest-host (GH), holographic polymer dispersed liquid crystal (HPDLC), cholesteric liquid crystal, or chiral nematic liquid crystal have been developed.

A reflective liquid crystal display unit becomes more visible as the environment becomes brighter, which is different from a transmissive liquid crystal display unit using backlighting. In other words, the reflective liquid crystal display unit is invisible unless the environment is bright and this also means that the brighter the environment is the more reflected light from the display unit surface increases. In the modes using polarizing plates, anti-glare treatment is applied to the polarizing plate surface to scatter the reflection from illumination light, whereby decline in visibility due to reflected images of the background and viewer is prevented.

However, in the abovementioned liquid crystal display units that do not use polarizing plates, reflection from the glass surfaces is much greater than that of the modes where the polarizing plates are adhered and the visibility is substantially damaged.

It is necessary for a display unit employing a mode using the abovementioned holographic polymer dispersed liquid crystal (HPDLC), cholesteric liquid crystal, or chiral nematic liquid crystal that some treatment to reduce reflection is applied to the glass surfaces thereof since no polarizing plates are used. It is demanded that reflective displays be usable in bright environments and be visible in the bright environment. However on the other hand, reflected light on the glass surface increases more and more in bright environments and visibility greatly deteriorates.

There are the following two causes for the deterioration in visibility of the reflective display panel. One of them is the decline in contrast. Reflected light from the glass surface is added to reflected light from a liquid layer, that is, the two reflected light are overlapped to work as flare light, thereby remarkably lowering contrast. Even though reflected images is eliminated by applying anti-glare treatment to the surface, the contrast lowers.

The other cause for the deterioration in visibility is that reflected images of the background or viewer overlaps with the contents being displayed. In the case of a reflective display used for a portable telephone or a personal digital assistant, it is possible for a viewer to move the liquid crystal display unit to avoid reflected images. However, it is still inconvenient to use such a unit. Furthermore, in the case of a large-sized display panel unit such as a bulletin board, since the board is fixedly installed, prevention of the abovedescribed reflected images is necessary. Although to devise an illuminating method can be considered as a measure for preventing reflected images as described above, this method is not for practical use since the cost increases, and furthermore when the large-sized display panel is used outdoors, since the position of installation of its illumination device is restricted, modification for illumination is impossible.

The object of the present invention is to solve the above described problems according to the prior art and improve visibility of the reflective display panel using a liquid crystal display unit.

### DISCLOSURE OF THE INVENTION

As a result of earnest study aimed at solving the abovementioned problems, the present inventor has successfully discovered that by providing reflection enhanced films on the surfaces of a transparent substrate such as glass plates of a liquid crystal display unit in a reflective display panel, a reflective liquid crystal display unit which is excellent in contrast, brighter than before the reflection enhanced films are provided, and which has less reflected images can be provided.

Of the liquid crystal display units that do not use polarizing plates or color filters, as with the liquid crystal display units using the holographic polymer dispersed liquid crystal (HPDLC), cholesteric liquid crystal, chiral nematic liquid crystal, or mixed liquid crystal composed of cholesteric liquid crystal and chiral nematic liquid crystal, a bright display can be realized by actively scattering incident light backward by utilizing Bragg reflection from the liquid crystal layer. Therefore, the present inventor has further discovered that visibility of the liquid crystal display units using these liquid crystal can be improved without reducing incident light by suppressing reflection from the transparent substrate surfaces.

By forming reflection enhanced films on the glass surfaces by coating, the present inventor has successfully suppressed the reflection from the transparent substrate surfaces without reducing the incident light, whereby a liquid crystal display unit which has less reflected images and higher contrast and which is bright and excellent in visibility can be provided.

The principle of the present invention will now be explained with reference to a cholesteric liquid crystal display unit as an example.

FIG. 1 shows a cross section of a cholesteric liquid crystal display unit and a course of external light made incident onto the cholesteric liquid crystal display unit. The cholesteric liquid crystal display unit mainly comprises a surface glass 1, a backing glass 2, and a cholesteric liquid crystal layer 3 disposed therebetween.

Illumination light Io passes through the surface glass 1 and is made incident onto the cholesteric liquid crystal layer 3. The cholesteric liquid crystal layer 3 has a structure where liquid crystal molecules are twisted and the central axis of the twist is referred to as a spiral axis (not illustrated). When the spiral pitch is within 0.25 μm to 0.46 μm along the spiral axis, Bragg reflection of visible light occurs.

Reflection enhanced films 4 and 5 are provided on the surface side of the surface glass 1 (on the viewer's side), that is, on the surface of the side where light is made incident and on the back side of the backing glass 2, that is, on the side where light made incident from the backing glass 2 reflects from the rear surface of the backing glass 2 toward the viewer's side, respectively.

In addition, the liquid crystal 3 have a bistable characteristic (where two states are stably maintained (memorized)). An oriented state where the spiral axis of the cholesteric liquid crystal 3 is almost vertical to the glasses 1 and 2 is referred to as a planer texture layer 3a while an oriented state where said spiral axis is almost parallel to the surfaces of the glass 1 and 2 is referred to as a focal conic texture layer 3b. These two states have been memorized even though a voltage is not applied. Light reflected by the planer texture layer 3a is reflected in the direction where it has been made incident, that is, toward the surface glass 1 side. On the other side, light reflected by the focal conic texture layer 3b advances in the direction of the backing glass 2. On the rear surface of the backing glass 2, light absorbent coating film 6 with a black coating is applied, and the light reflected by the focal conic texture layer 3b is absorbed by the light absorbent coating film 6. Namely, the cholesteric liquid crystal 3 can be utilized as a display panel by appropriately selecting the planer texture layer 3a or the focal conic texture 3b. Covering of the reflection enhanced film 5 is unnecessary when the light absorbent coating film 6 is coated with a film having the same refractive index as that of the backing glass 1.

Herein, reflectance on the surface 1a of the surface glass 1 is provided as rs, reflectance from the planer texture layer 3a of the cholesteric liquid crystal 3 is provided as rp, reflectance from the focal conic texture layer 3b is provided as rf, and reflectance on the surface 2a of the backing glass 2 is provided as rb. Reflection on the rear surface 1b of the surface glass 1 and reflection on the rear surface 2b of the backing glass 2 are ignored since the refractive index of glass and the refractive index of liquid crystal are approximate. Also, an amount of reflected light from the planer texture layer 3a of the cholesteric crystal liquid 3 is provided as Rp and an amount of reflection from the focal conic layer of the same is provided as Rf, and in terms of an amount of reflected light on the surface 2a of the backing glass 2, amounts of reflected light on the planer texture layer 3a and the focal conic texture layer 3b are provided as Rbp and Rbf, respectively. At this time, contrast is expressed by the following formula.

$$Contrast = ( Rp + Rs + Rbp ) / ( Rf + Rs + Rbf ) \\ Herein , \\ \begin{matrix}Rs = I \cdot rs , \\ Rp = I ( 1 - rs ) rp , \\ Rf = I ( 1 - rs ) rf , \\ Rbp = ( I - Rs - Rp ) rb , and \\ Rbf = ( I - Rs - Rf ) rb .\end{matrix} \qquad ( 1 )$$

The numerator and denominator of the above formula can be expressed as follows,

$$\begin{matrix}Numerator = Rp + Rs + Rpb \\ = I ( 1 - rs ) rp + I \cdot rs + ( I - Rs - Rp ) rb \\ = I ( \{ rp + ( 1 - rp ) ( 1 - rb ) rs + ( 1 - rp ) rb \}\end{matrix}$$

Similarly,

Denominator=I{rf+(1−rf)(1−rb)rs+(1−rf)rb}

Accordingly, the above formula (1) can be rewritten to be the following formula (2).

$$Contrast = \{ rp + ( 1 - rp ) ( 1 - rb ) rs + ( 1 - rp ) rb \} / \{ rf + ( 1 - rf ) ( 1 - rb ) rs + ( 1 - rf ) rb \} \qquad ( 2 )$$

As mentioned before, the rp and rf are coefficients (reflectance) according to the liquid crystal layers and the rs and rb are coefficients (reflectance) according to the glass surfaces, and when rp=0.4 and rf=0.005 are fixed, the changes in contrast when the coefficients rs and rb are changed can be calculated as follows.

In actuality, the reflectance rp of the planer texture layer 3a of the cholesteric liquid crystal 3 is approximately 40% while the reflectance rf of the focal conic texture layer 3b thereof is approximately 0.5%. The reflectance rs of the surface of the surface glass is 4% when no treatment is applied. Also, the light absorbent film 6 is coated on the backing glass 2 and the reflectance rb of the rear surface is provided as 0.25%.

To what extent the contrast improves as the reflectance reduces is shown in FIG. 3. FIG. 3 indicates that the contrast remarkably improves from approximately 10 to approximately 50 as the surface reflectance rs of the glass 1 on the surface side (on the viewer's side).

Thus, by suppressing the reflectance rs on the surface 1a of the surface glass 1 and the reflectance rb on the surface 2a of the backing glass 2, the contrast can be remarkably improved.

According to characteristics of the reflection enhanced films 4 and 5, the lower the reflectance is the greater visibility becomes, however, a decision should be made upon the costs and production process.

As the reflection enhanced films 4 and 5, a film comprising materials such as SiO₂, TiO₂, MgF₂, and Nb₂O₅ laminated by sputtering or vacuum evaporation to form a multi-layer can be used. According to this kind of film, low reflectance can be realized over the whole visible light area by increasing the number of layers. However, there is a drawback in that the greater the number of the layers becomes, the higher the cost becomes.

On the other hand, a monolayer deposition film using SiO₂ or MgF₂ is low in cost. It is appropriate to produce a reflection enhanced film composed of a monolayer film having a thickness one fourth of the wavelength of yellowish green light, that is the light humans sense as the brightest . Reflected light at this time is purple which is a complementary color of the yellowish green light. When the cost aspect is further taken into consideration, a method whereby a sol-gel solution of SiO₂ is coated by dipping may be employed. TiO₂may be added to adjust the refractive index.

The reflection enhanced films 4 and 5 may be provided on the surface of a liquid crystal display panel after completion or on the surface glass 1 and the backing glass 2 on which ITO electrodes 7 and 8 (FIG. 1) have not yet attached. When the production process of the liquid crystal is taken into consideration, the latter case is preferable. However, in said case, it is required that the reflection enhanced films 4 and 5 have heat resistance, acid resistance, and alkali resistance capable to withstand an ITO film production and ITO etching process. Such requirements can be sufficiently satisfied when the reflection enhanced films 4 and 5 using SiO₂ as a base material thereof are used.

In a liquid crystal display unit of the present invention as shown in FIG. 1, the reflection enhanced films 4 and 5 are provided on the surface side (viewer's side) of the surface glass 1 and on the back side of the backing glass 2, respectively. However, the liquid crystal display unit of the present invention may be constructed by providing the reflection enhanced film 4 only on the surface side (viewer's side) of the surface glass 1.

The present invention can be applied not only to the cholesteric liquid crystal 3 but also to all liquid crystal display units of the Bragg reflection type, and it can also be applied to reflective liquid crystal display units using chiral nematic liquid crystal, mixed liquid crystal composed of cholesteric liquid crystal 3 and chiral nematic liquid crystal, or holographic polymer dispersed liquid crystal.

### BRIEF DESCRIPTION OF THE DRAWINGS

FIG. 1 is a view showing a sectional structure and reflected light of the liquid crystal display unit according to the present invention.

FIG. 2 is a view showing a sectional structure and reflected light of the liquid crystal display unit according to an embodiment of the present invention.

FIG. 3 is a graph showing the relationship between reflectance of the glass surface on the incidence side and contrast.

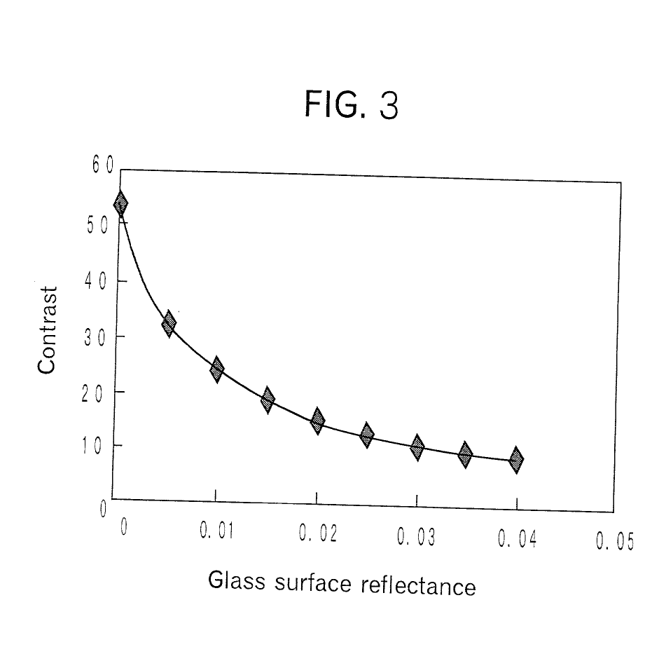

FIG. 4(a) shows measurement results of spectral reflectance of the planer texture layer and focal conic texture layer according to the present invention, and FIG. 4(b) shows measurement values of spectral reflectance of the liquid crystal display unit according to the prior art.

FIG. 5 is a graph showing the relationship in actual measurements between the ratio of reflectance of the planer texture to reflectance of the focal conic texture at a light receiving angle of 0° of a measuring apparatus with respect to a liquid crystal display element and contrast.

FIG. 6 is Measurement results of chromaticity.

### BEST MODE FOR CARRYING OUT THE INVENTION

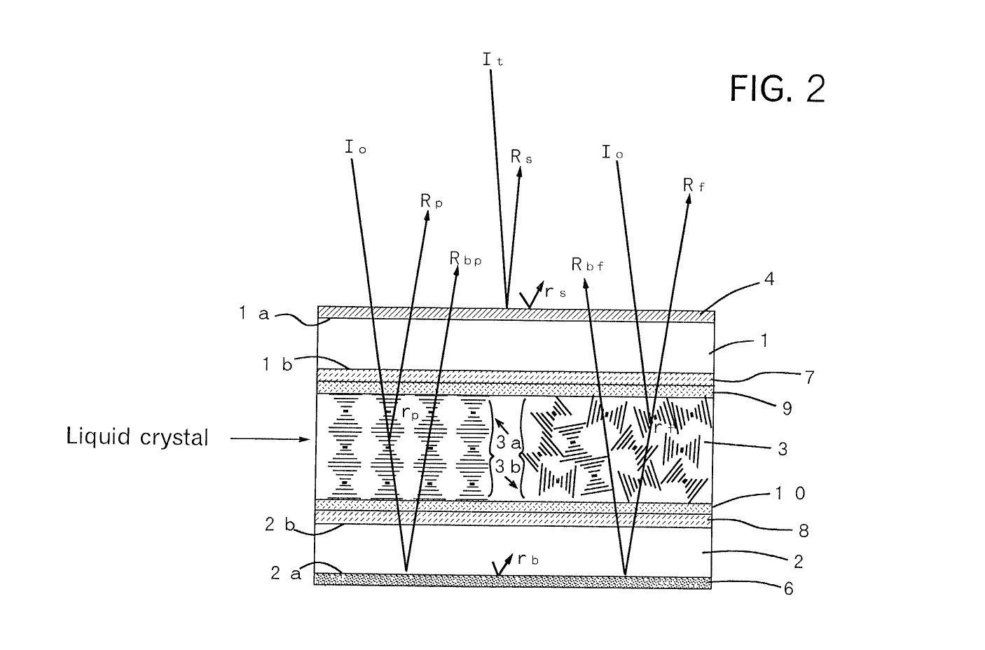

As a preferred embodiment of the present invention, a liquid crystal display unit as shown in FIG. 2 is produced through the following procedures.

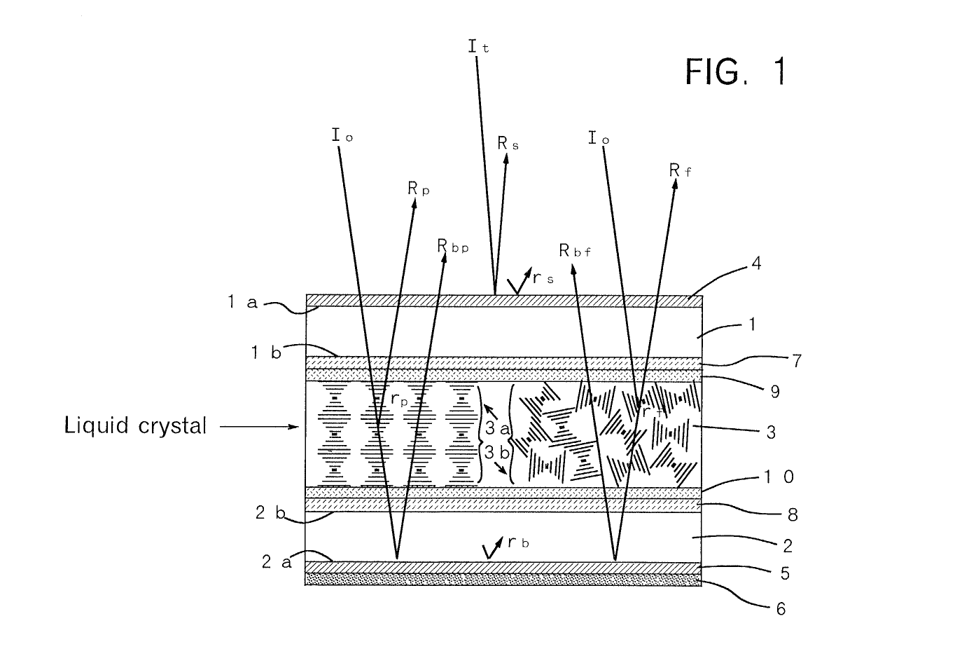

The liquid crystal display unit of FIG. 2 mainly comprises the surface glass 1, the backing glass 2, and the cholesteric liquid crystal 3 disposed therebetween, and a thin sheet glass substrate (manufactured by Nippon Sheet Glass Co., Ltd.) having a thickness of 1.1 mm is used for the surface glass 1 and the backing glass 2. The liquid crystal display unit as shown in FIG. 2 is different from the liquid crystal display unit as shown in FIG. 1 in only the point that the reflection enhanced film 5 is not provided on the rear surface side of the backing glass 2.

In the liquid crystal display unit of FIG. 2, on one surface of the surface glass 1, SiO₂—Nb₂O₅—TiO₂—SiO₂ is deposited to produce the reflection enhanced film 4 (CDAR manufactured by Viratec Co., Ltd.) by sputtering, while on one surface of the backing glass 2, light absorbent coating film 6 is applied. On the surface of the surface glass 1 opposite to the surface where the reflection enhanced film 4 has been applied and on the surface of the backing glass 2 opposite to the surface where the light absorbent coating film 6 has been applied, ITO is deposited by sputtering to produce films that serve as ITO films 7 and 8 in the liquid crystal display unit of FIG. 1. After the ITO films 7 and 8 are etched by a photolithography method, vertically oriented film 9 and 10 of SE-1211 (Nissan Chemical Co., Ltd.) is formed thereon.

On a first sheet of the two plates thus obtained, plastic spacers (not illustrated) are scattered, while on the other sheet, a sealing agent made of an epoxy resin (not illustrated) is formed by a screen printing. These two plates are adhered to each other by pressure with the reflection enhanced film 4 oriented toward the outside and then heated, whereby the sealing agent is hardened. These two plates thus adhered are cut into a predetermined size and liquid crystal in a chiral nematic state, which is produced by adding a chiral agent, such as phenylpropinic acid or cholesteryl nanoate, to nematic liquid crystal used as mother liquid crystal, such as cyanobiphenyl liquid crystal, cyanoterphenyl liquid crystal, cyanophenyl cyclohexane liquid crystal, and cyanophenyl ester liquid crystal so as to be cholesteric liquid crystal as a crystalystem are injected in the space between two plates. After the injection of the liquid crystal, the injection port is sealed by a ultraviolet curing resin.

FIG. 2 shows a section of a cholesteric liquid crystal display unit and the course of external light made incident onto the liquid crystal display unit. Similar to the description of FIG. 1, illumination light Io passes through the surface glass 1 and is made incident onto the cholesteric liquid crystal layer 3. The cholesteric liquid crystal 3 have a structure where liquid crystal molecules are twisted and the central axis of the twist is referred to as a spiral axis (not illustrated). When the spiral pitch is within 0.25 μm to 0.46 μm along the spiral axis, Bragg reflection of visible light occurs.

A pulse voltage of 40V is applied to a part of a unit of the liquid crystal display unit of FIG. 2, whereby said liquid crystal layer 3 is provided as a liquid crystal layer 3a equivalent to the planer texture layer 3a of the liquid crystal display unit of FIG. 1 and a pulse voltage of 30V is applied to another part, whereby said liquid crystal layer is provided as a layer equivalent to the focal conic texture layer 3b of the liquid crystal display unit of FIG. 1.

Spectral reflectance, contrast, and chromaticity of the planer texture layer 3a in the liquid crystal display unit obtained are measured by means of a luminance meter, LCD 7500 manufactured by Otsuka Electronics Co., Ltd.

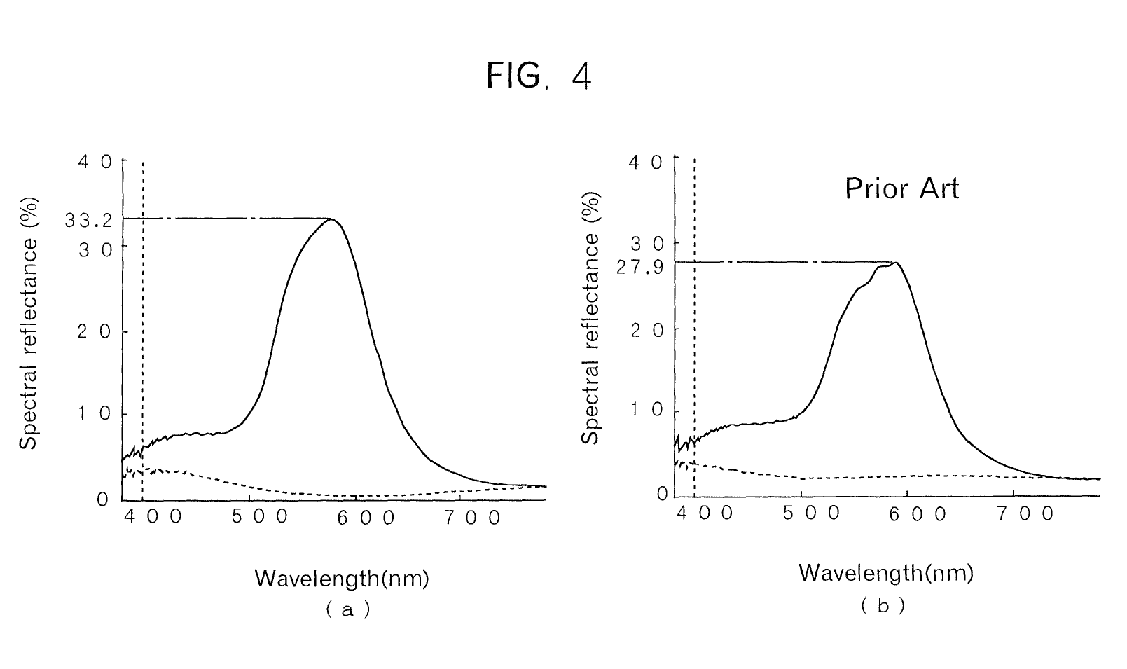

FIG. 4 (a) shows measurement results of spectral reflectance (solid line) of the planer texture layer 3a and spectral reflectance (dotted line) of the focal conic texture layer 3b in a case where the reflection enhanced film 4 is provided on the surface of the surface glass land the light absorbent coating 6 is provided on the rear surface of the backing glass 2 as shown in the liquid crystal display unit of FIG. 2.

FIG. 4(b) shows measurement values of spectral reflectance of the prior-art liquid crystal display unit, which are obtained by a method which does not employ the step for forming the reflection enhanced film 4 in the abovedescribed production method for the liquid crystal display unit.

According to the measurement results of the FIG. 4(a) and FIG. 4(b), the reflectance (solid line) of the planer texture layer 3a is higher than the reflectance (dotted line) of the focalconictexturelayer3basexpected. However, surprisingly, it is discovered that the reflectance of the planer texture layer 3a (reflectance of FIG. 4 (a) (solid line)), on which the reflection enhanced film 4 has been provided, is higher than the reflectance of the planer texture layer 3a (reflectance of FIG. 4 (b) (solid line)), on which the reflection enhanced film 4 has not been provided. In addition, the peak reflectance increased from 27.9% to 33.2%, that is, improved by 5.3 points, 19% (5.3/27.9), thus indicating a very bright display.

Moreover, when the measurement results of FIG. 4(a) and FIG. 4(b) are compared, the reflectance of the focal conic texture layer 3b (dotted line) is suppressed below a case in which the reflection enhanced film 4 has not been provided. This indicates that though in a case where the reflection enhanced film 4 is provided, more light is made incident onto liquid crystal region than in the case where the reflection enhanced film 4 is not provided, said light is easily reflected by the planer texture layer 3a whereas said light is hardly reflected by the focal conic texture layer 3b. Consequently, the brightness of display is improved and contrast is also improved. The measurement results of contrast are shown in Table 1. Lightness is reflectance compensated by a luminosity factor and indicates the brightness that humans sense. In terms of the planer texture layer 3a, the lightness of the product of the invention is higher than that of the prior art, thus indicating greater brightness, and in terms of the planer texture layer 3b, the lightness of the product of the invention is lower than that of the prior art, thus indicating a darkish view. As a result, the product of the present invention is substantially improved in terms of contrast.

TABLE 1

| | Product of the | Product of the |
|---|---|---|
| | present invention | prior art |
| Planer texture lightness | 24.22 | 20.76 |
| Focal conic texture lightness | 0.98 | 2.45 |
| Contrast | 24.7 | 8.5 |

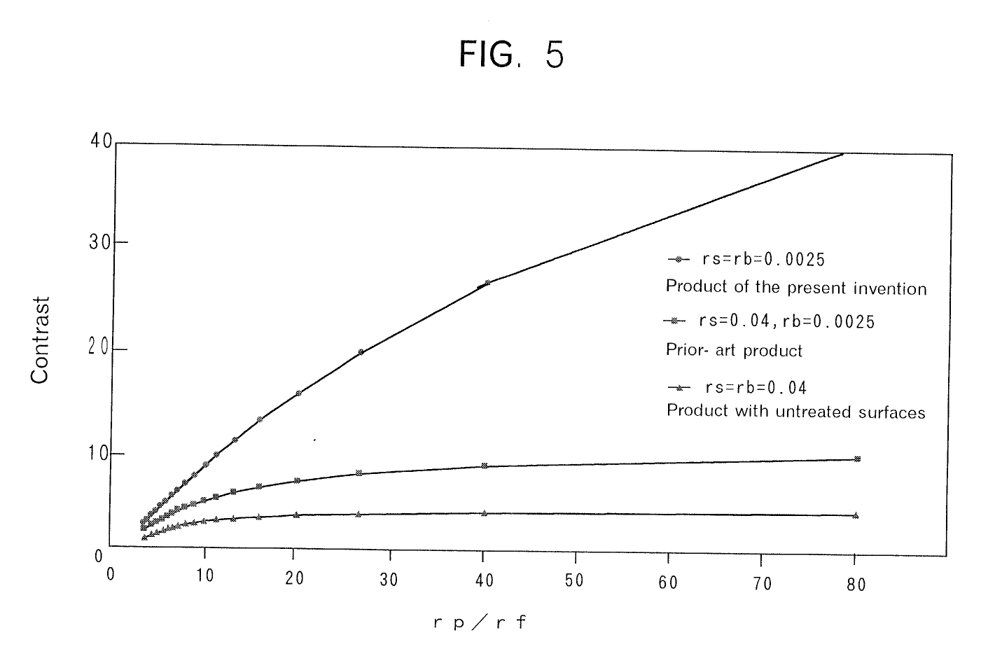

FIG. 5 shows the relationship in actual measurements between the ratio of reflectance rp from the planer texture 3a to reflectance rf from the focal conic texture 3b (rp/rf) and the contrast defined by the abovedescribed formula (1). FIG. 5 indicates that even though the ratio (rp/rf) showing contrast of the liquid crystal layers is great, unless reflection from the glass surface is suppressed, improved contrast of the display cannot be realized.

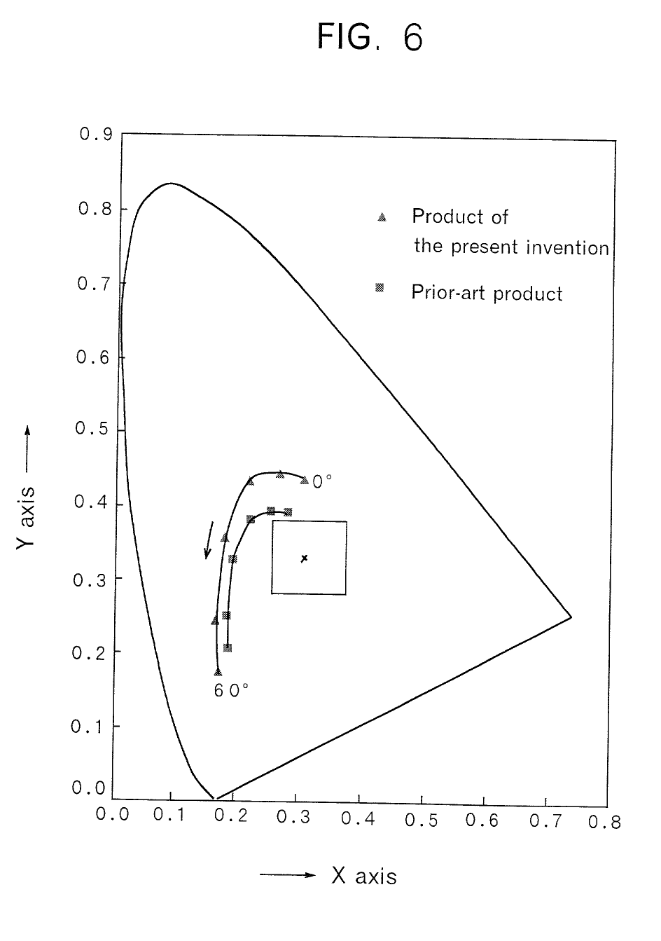

Furthermore, FIG. 6 shows measurement results of chromaticity (values measured at a light receiving angle of 10, 20, 30, 40, and 50° of a measuring apparatus with respect to a liquid crystal display unit) of a liquid crystal display unit with the reflection enhanced films of the present invention (reflection enhanced films is coated on a surface glass 1 as shown in FIG. 2) and a liquid crystal display unit without the reflection enhanced films of the prior art. The values of the liquid crystal display unit with reflection enhanced films of the present invention are plotted on the outside compared to those of the liquid crystal display unit with no reflection enhanced films of the prior art. That is, the purity (chroma) of colors of the liquid crystal display unit with reflection enhanced films of the present invention is improved compared to that of the liquid crystal display unit with no reflection enhanced films of the prior art.

Capability of Exploitation in Industry

Thus, according to the present invention, by providing reflection enhanced films on the surfaces of a transparent substrate, reflected light becomes bright compared to that of a case with no reflection enhanced films and a liquid crystal display unit having higher contrast, higher color purity, and excellent visibility with less reflected images compared to a liquid crystal display unit with no reflection enhanced films can be achieved.

What is claimed is:

1. A reflective liquid crystal display unit in which a liquid crystal layer, which causes Bragg reflection, comprising
cholesteric liquid crystal, chiral nematic liquid crystal, mixed liquid crystal composed of cholesteric liquid crystal and chiral nematic liquid crystal, or holographic polymer dispersed liquid crystal is formed between two conductive substrates at least one of which is transparent, wherein
a reflection enhanced film is provided on the surface of the conductive substrate on the light incidence side.

2. A reflective liquid crystal display unit as set forth in claim 1, wherein a reflection enhanced film is provided also on the surface of the conductive substra te on the back side.

3. A reflective liquid crystal display unit as set forth in claim 1, wherein a light absorbent coating having the same refractive index as that of the conductive substrate on the back side is coated on the surface of said conductive substrate on the back side.
